(19) United States
(12) Patent Application Publication
(10) Pub. No.: US 2024/0296434 A1
(43) Pub. Date: Sep. 5, 2024

(54) UNIVERSAL PAYMENT GATEWAY CONNECTOR FOR A MULTI-TENANT COMPUTING ENVIRONMENT

(71) Applicant: Zuora, Inc., Redwood City, CA (US)

(72) Inventors: Adam Chiu, Redwood City, CA (US); Leon Liu, Redwood City, CA (US); Dhrumil Munshi, Redwood City, CA (US); Karol Chudy, Redwood City, CA (US); Tyler Schemmel, Redwood City, CA (US)

(73) Assignee: Zuora, Inc., Redwood City, CA (US)

(21) Appl. No.: 18/582,435

(22) Filed: Feb. 20, 2024

Related U.S. Application Data
(60) Provisional application No. 63/449,244, filed on Mar. 1, 2023.

(51) Int. Cl. G06Q 20/22; G06Q 20/02; G06Q 20/40

(52) U.S. Cl. CPC G06Q 20/22; G06Q 20/027; G06Q 20/405

(57) ABSTRACT

Systems, methods, and computer-readable media are disclosed for implementing a universal payment connector module that enables a subscription billing engine of a multi-tenant computing system/computing environment to connect to one or more payment gateways in a manner that permits the multi-tenant system/environment to facilitate processing of a payment transaction at a payment gateway without requiring modification of payment field names of the payment transaction that are native to the multi-tenant system/environment to gateway-specific field names. In addition, systems, methods, and computer-readable media are disclosed that enable a tenant of the multi-tenant system/computing environment to define a custom payment method type and to request payments to be created based on the custom-defined payment method type.

### PRIORITY

This application is a nonprovisional application which claims the benefit of U.S. Provisional Application Ser. No. 63/449,244, entitled “Universal Payment Gateway Connector For A Multi-Tenant Computing Environment,” filed Mar. 1, 2023, which is incorporated by reference in its entirety herein for all purposes.

### TECHNICAL FIELD

This disclosure pertains to multi-tenant computing systems, and more particularly to a universal payment gateway connector between a multi-tenant computing environment and one or more payment gateways.

### BACKGROUND

In a multi-tenant computing environment, one or more of the tenants may operate according to a subscription-based model, whereby subscribers of a tenant receive one or more services from the tenant on a continuous or periodic basis and are billed for the services on a subscription basis. In a typical subscription billing scenario, an account holder/subscriber is periodically billed according to a schedule established by the tenant and/or customized by the subscriber. The subscriber's profile may be associated with one or more forms of payment, and the tenant (or a service provider that manages the multi-tenant computing environment) may initiate a payment attempt against a selected form of payment according to a payment schedule. The payment schedule may be established by the tenant and/or customized by the subscriber. Payment attempts may be triggered automatically or may occur in response to a manual trigger such as when a subscriber manually schedules a payment. A payment attempt may include initiating a payment transaction against a payment gateway. Different payment gateways may require different sets of information to process a payment.

### SUMMARY

Systems, methods, and computer-readable media are disclosed for implementing a universal payment connector module that enables a subscription billing engine of a multi-tenant computing system/computing environment to connect to one or more payment gateways in a manner that permits the multi-tenant system/environment to facilitate processing of a payment transaction at a payment gateway without requiring modification of payment field names of the payment transaction that are native to the multi-tenant system/environment to gateway-specific field names. By obviating the need for the multi-tenant system/environment to generate such a payment field mapping between native field names and payment gateway-specific field names—which conventionally would need to be generated for each new tenant integration with the subscription billing engine—embodiments of the disclosed technology are scalable across any number of tenants, and thus, provide a technical solution to the technical problem of lack of scalability associated with conventional new tenant integration.

In addition, systems, methods, and computer-readable media are disclosed that enable a tenant of the multi-tenant system/computing environment to define a custom payment method type and to request payments to be created based on the custom-defined payment method type. More specifically, according to example embodiments of the disclosed technology, a tenant is provided with the capability to leverage a corresponding application programming interface (API) to provide the custom payment method type definition. The custom payment method type definition may specify one or more custom-defined payment fields to be included in a payment method object. The custom-defined payment fields may be included in the payment method object in addition to standard/default payment fields. Additional APIs may be provided as well to enable a tenant (or other entity requesting a payment on behalf of a tenant) to publish the custom payment method type definition, query the custom payment method type definition, and/or update the custom payment method type definition. Thus, embodiments of the disclosed technology provide a technical improvement over conventional payment generation by providing tenants with the capability to generate custom payment method type definitions that include one or more custom-defined payment fields beyond those fields that are included as standard/default fields of a payment method object, which a tenant (or other requesting entity) can then leverage to create payments that include payment attribute information populated in the custom-defined fields, in addition to default payment attribute information populated in the default fields.

In accordance with some embodiments, the present invention provides a method, comprising receiving, at a multi-tenant system, via a call to a first application programming interface (API), a payload comprising a custom payment method type definition associated with a particular tenant of the multi-tenant system; identifying one or more custom-defined payment fields in the custom payment method type definition; generating a template payment method object comprising one or more default payment fields and the one or more custom-defined payment fields; and storing the template payment method object in association with an identifier of the particular tenant.

The method may further comprise determining that the payload comprises the custom payment method type definition based on receiving the payload via the call to the first API. Identifying the one or more custom-defined payment fields may comprise determining, from the custom payment method type definition, a respective data type for each of the one or more custom-defined payment fields. The method may further comprise receiving, at the multi-tenant system, via a call to a second API, a request to update the custom payment method type definition; and modifying the custom payment method type definition responsive to receiving the request via the call to the second API. Modifying the custom payment method type definition may comprise at least one of adding a new custom-defined payment field, removing an existing custom-defined payment field, or changing a respective data type of the existing custom-defined payment field.

In accordance with some embodiments, the present invention provides a computer program product comprising a non-transitory computer-readable medium readable by a processing circuit, the non-transitory computer-readable medium storing instructions executable by the processing circuit to cause a method to be performed, the method comprising receiving, at a multi-tenant system, via a call to an application programming interface (API), a request to create a payment; identifying, from the request to create the payment, a specified endpoint for the payment; determining a custom payment method type definition corresponding to the requested payment; generating a payment method object based on the custom payment method type definition; and sending the payment method object to the specified endpoint.

The specified endpoint may be a system external to the multi-tenant system, the third-party service system being configured to transform one or more payment fields in the payment method object to one or more payment gateway-specific payment fields and send the payment method object to a particular payment gateway. Determining the custom payment method type definition corresponding to the requested payment may comprise determining an identifier associated with the request to create the payment; and determining that the custom payment method type definition is stored in association with the identifier. The identifier may identify a particular tenant of the multi-tenant system. Generating the payment method object based on the custom payment method type definition may comprise determining a plurality of payment fields included in the custom payment method type definition, the plurality of payment fields including one or more default payment fields and one or more custom-defined payment fields; identifying payment attribute information relating to the request to create the payment; and populating the plurality of payment fields with the payment attribute information. Generating the payment method object based on the custom payment method type definition may comprise determining a template payment method object that corresponds to the custom payment method type definition; and instantiating the template payment method object to generate the payment method object. Instantiating the template payment method object may comprise accessing stored payment attribute information associated with the request to create the payment; and populating a plurality of payment fields of the template payment method object with the payment attribute information. Populating the plurality of payment fields may comprise identifying a custom-defined payment field among the plurality of payment fields; determining an expected data type for the custom-defined payment field; identifying a portion of the payment attribute information that corresponds to the custom-defined payment field; determining that a data type of the portion of the payment attribute information matches the expected data type; and populating the custom-defined payment field with the portion of the payment attribute information.

In accordance with some embodiments, the present invention provides a multi-tenant system, comprising memory storing computer-executable instructions; and at least one processor configured to access the memory and execute the computer-executable instructions to receive, via a call to a first application programming interface (API), a payload comprising a custom payment method type definition associated with a particular tenant of the multi-tenant system; receive, via a call to a second API, a request to create a payment; identify, from the request to create the payment, a specified endpoint for the payment; determine that the custom payment method type definition corresponds to the requested payment; generate a payment method object based on the custom payment method type definition; and send the payment method object to the specified endpoint.

The at least one processor may be further configured to execute the computer-executable instructions to receive, via a call to a third API, a request to update the custom payment method type definition; and modify the custom payment method type definition responsive to receiving the request via the call to the third API. The at least one processor may be configured to modify the custom payment method type definition by executing the computer-executable instructions to at least one of add a new custom-defined payment field, remove an existing custom-defined payment field, or change a respective data type of the existing custom-defined payment field. The at least one processor may be configured to determine the custom payment method type definition corresponding to the requested payment by executing the computer-executable instructions to determine an identifier associated with the request to create the payment, the identifier identifying the particular tenant; and determine that the custom payment method type definition is stored in association with the identifier. Responsive to receiving the payload comprising the custom payment method type definition, the at least one processor may be further configured to execute the computer-executable instructions to identify one or more custom-defined payment fields in the custom payment method type definition; generate a template payment method object comprising one or more default payment fields and the one or more custom-defined payment fields; and store the template payment method object and the custom payment method type definition in association with an identifier of the particular tenant. The at least one processor may be configured to generate the payment method object based on the custom payment method type definition by executing the computer-executable instructions to access the stored template payment method object corresponding to the custom payment method type definition based on its stored association with the identifier of the particular tenant; and instantiate the template payment method object to generate the payment method object. The at least one processor may e configured to instantiate the template payment method object by executing the computer-executable instructions to access stored payment attribute information associated with the request to create the payment; and populate a plurality of payment fields of the template payment method object with the payment attribute information. The at least one processor may be configured to populate the plurality of payment fields by executing the computer-executable instructions to identify a custom-defined payment field among the plurality of payment fields; determine an expected data type for the custom-defined payment field; identify a portion of the payment attribute information that corresponds to the custom-defined payment field; determine that a data type of the portion of the payment attribute information matches the expected data type; and populate the custom-defined payment field with the portion of the payment attribute information.

Any of the above-described method, system, and/or computer program product embodiments can be combined in any manner to obtain additional embodiments of the disclosed technology. In particular, any feature, component, aspect, or the like of a given embodiment can be combined with any other feature, component, aspect, or the like of any other embodiment to obtain another embodiment of the disclosed technology.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the disclosed technology are set forth with particularity in the appended claims. A better understanding of the features and advantages of the disclosed technology will be obtained by reference to the following detailed description that sets forth illustrative embodiments, in which the principles of the technology are utilized, and the accompanying drawings of which:

FIG. 1 is a block diagram illustrating a network system that includes a multi-tenant system configured to provide cloud-based software-as-a-service (SaaS) services to multiple tenants in accordance with example embodiments of the disclosed technology.

FIG. 2 is a block diagram illustrating a network system in which a multi-tenant system is connected to one or more payment gateways via a universal payment connector module of the multi-tenant system in accordance with example embodiments of the disclosed technology.

FIG. 3A is a schematic diagram illustrating a process of defining a custom payment method type in accordance with example embodiments of the disclosed technology.

FIG. 3B is a schematic diagram illustrating a process of creating a payment based on a custom payment method type definition in accordance with example embodiments of the disclosed technology.

FIG. 4 is a flowchart illustrating a method of defining a custom payment method type in accordance with example embodiments of the disclosed technology.

FIG. 5 is a flowchart illustrating a method of creating a payment based on a custom payment method type definition in accordance with example embodiments of the disclosed technology.

FIG. 6 is a block diagram illustrating a computing device that may form part of a computing system configured to implement features disclosed herein in accordance with example embodiments of the disclosed technology.

### DETAILED DESCRIPTION

Execution of a payment transaction involves a series of exchanges among various systems. During processing of a payment transaction, a payment processor system may submit a payment request to a payment gateway. In some cases, a multi-tenant system may create the payment request on behalf of a tenant and send the payment request to the payment processor system, which in turn, may forward the payment request to the payment gateway. The multi-tenant system may provide SaaS services including, for example, subscription billing services to multiple tenants. For instance, a tenant (e.g., an enterprise customer) may rely on the SaaS functionality of a multi-tenant system to manage the subscription billing of the tenant's subscriber base, which could potentially include millions of subscribers. Subscription billing SaaS functionality may include, without limitation, invoice generation, payment scheduling, payment transaction initiation, failed payment retry, collection activities, and the like.

As part of the subscription billing services it provides, the multi-tenant system may generate payment requests on behalf of its tenants and forward the payment requests to a downstream (or upstream) payment hub/processor-potentially via one or more intermediary systems/services. In particular, the multi-tenant system may receive a request to initiate a payment from a tenant or another requesting entity acting on behalf of tenant. The payment initiation request may specify subscriber details for the subscriber to whom the payment relates such as a subscriber identifier. The multi-tenant system may then retrieve payment attribute information associated with the subscriber using the subscriber identifier, populate payment fields of a payment method object with the retrieved payment attribute information, and send a payment request that includes the payment method object to a payment gateway.

In at least some cases, a payment gateway may utilize names for payment fields that differ from the names natively used by the multi-tenant system. For example, a particular payment field may be referred to as “name” in the multi-tenant system, but a corresponding payment field (i.e., a payment field that is populated with the same data attribute) may be referred to as “username” in the payment gateway. To accommodate this potential discrepancy in payment field names, a field name mapping may be generated to map payment field names that are used within the multi-tenant system to gateway-specific field names. Generating this field name mapping is cumbersome and difficult to scale. In particular, generating the field name mapping typically involves manually coding the mapping relationship between the field names used within the multi-tenant system and the field names used within a payment gateway. This is a tedious process that is then repeated for each new tenant integration to the subscription billing engine of the multi-tenant system. As such, the process is not scalable as the number of tenants that are onboarded increases.

Systems, methods, and computer-readable media are disclosed for implementing a universal payment connector (UPC) module that enables a subscription billing engine of a multi-tenant system to connect to one or more payment gateways in a manner that permits the multi-tenant system to request processing of a payment transaction at a payment gateway without having to modify payment field names of the payment transaction that are native to the multi-tenant system to gateway-specific field names. By obviating the need for the multi-tenant system to generate such a payment field mapping between native field names and payment gateway-specific field names—which conventionally would need to be done for each new tenant integration with the subscription billing engine—embodiments of the disclosed technology are scalable across any number of tenants, and thus, provide a technical solution to the technical problem of lack of scalability associated with conventional new tenant integration.

In addition, systems, methods, and computer-readable media are disclosed that enable a tenant of the multi-tenant system to define a custom payment method type and to request payment requests based on the custom-defined payment method type. More specifically, according to example embodiments of the disclosed technology, a tenant is provided with the capability to leverage a corresponding application programming interface (API) to provide the custom payment method type definition. The custom payment method type definition may specify one or more custom-defined payment fields to be included in a payment method object. The custom-defined payment fields may be included in the payment method object in addition to standard/default payment fields. Additional APIs may be provided as well to enable a tenant (or other entity requesting a payment on behalf of a tenant) to publish the custom payment method type definition, query the custom payment method type definition, and/or update the custom payment method type definition. Thus, embodiments of the disclosed technology provide a technical improvement over conventional payment generation by providing tenants with the capability to generate custom payment method type definitions that include one or more custom-defined payment fields beyond those fields that are included as standard/default fields of a payment method object, which a tenant (or other requesting entity) can then leverage to create payment requests that include payment attribute information populated in the custom-defined fields, in addition to default payment attribute information populated in the default fields.

An overview of various example embodiments of the disclosed technology has been presented above. A more detailed discussion of these and other embodiments of the disclosed technology will now be provided. It should be appreciated any embodiments individually described herein can be combined in any manner to yield additional embodiments of the disclosed technology. It should further be appreciated that discussion herein of one or more aspects of any particular embodiment shall not be construed as an admission that such aspect(s) are not also shared by other embodiments of the disclosed technology.

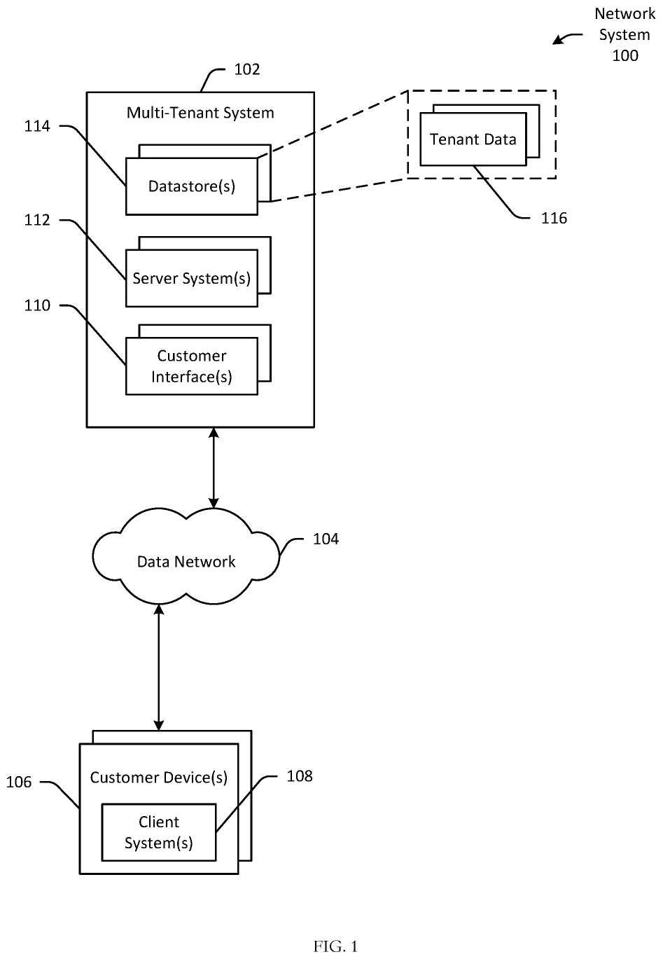

FIG. 1 depicts a diagram of an example network system 100 for providing cloud-based SaaS services of a multi-tenant system 102 to multiple tenants according to example embodiments. Examples of such cloud-based SaaS services include data storage, data processing, and business-oriented applications. In some embodiments, each tenant may be a subscription-based entity or provider (e.g., an internet service provider, a home security system and service provider, a cellular phone service provider, an entertainment content provider, etc.). A respective group of one or more users (e.g., individuals, business entities, customers of the business entities, systems, etc.) may share access to the cloud-based services provided to each tenant by the multi-tenant system 102. In some example embodiments, a tenant corresponds to a service entity such as AT&T™, Netflix™, Verizon™, and/or the like. In some example embodiments, a tenant may correspond to one or more products or services offered by an entity. For example, in an example embodiment, AT&T internet products and AT&T security products may be separate and distinct tenants. In some example embodiments, the cloud-based SaaS services relate to managing subscriber records, product and/or service consumption information, billing information, payment information, and/or the like.

The network system 100 includes the multi-tenant system 102 coupled via a data network 104 (e.g., a set of one or more public and/or private, wired and/or wireless networks) to client/customer devices 106. The multi-tenant system 102 includes shared resources for hosting the cloud-based SaaS services provided to the tenants. The shared resources may include processors, memory, virtual systems, services, application programs, load balancers, firewalls, and so forth. As depicted in FIG. 1, the multi-tenant system 102 may include tenant/customer interfaces 110, server systems 112, and datastores 114. Each of the client devices 106 may include a client system 108 that accesses the cloud-based SaaS services hosted by the multi-tenant system 102. In example embodiments, the client systems 108 may be operated by employees (e.g., administrator users) of the provider of the multi-tenant system 102; by employees of the tenants; and/or by end users of the tenants' services.

Each client device 106 may include a personal computing device such as a desktop computer, a laptop computer, a notebook, a tablet, a personal digital assistant (PDA), a smartphone, a wearable computing device, and/or any other consumer electronic device incorporating one or more computer components. The client system 108 on each client device 106 may include hardware, software, and/or firmware for communicating with the multi-tenant system 102 and accessing the cloud-based services hosted by the multi-tenant system 102. Examples of the client systems 108 may include, without limitation, web browsers, client engines, drivers, user interface components, proprietary interfaces, and so forth.

The multi-tenant system 102 may include hardware, software, and/or firmware for hosting cloud-based services for tenants. In example embodiments, the multi-tenant system 102 may offer access to shared resources including systems and applications on shared devices and may offer each tenant the same quality of service or may offer different tenants varying qualities of service. In some example embodiments, the multi-tenant system 102 may not use virtualization or instantiation processes. In some example embodiments, the multi-tenant system 102 may integrate several business computing systems into a common system with a view toward streamlining business processes and increasing efficiencies on a business-wide level.

In some example embodiments, the multi-tenant system 102 includes a user interface tier of multiple tenant interfaces 110, a server tier of multiple server systems 112, and a datastore tier of multiple datastores 114 for the multiple tenants. In some example embodiments, the tenant interfaces 110 may include graphical user interfaces and/or web-based interfaces to enable tenants to access the shared services hosted by the multi-tenant system 102. The tenant interfaces 110 may support load balancing when multiple tenants (and/or multiple customers of the tenants) attempt to access the multi-tenant system 102 concurrently. The tenant interfaces 110 may additionally or alternatively include an operator interface for use by a systems operator to configure or otherwise manage configuration settings or the like for the multi-tenant system 102. In some example embodiments, to support load balancing, each tenant may be associated with a subset of the total number of tenant interfaces 110.

In some example embodiments, the server systems 112 may include hardware, software, and/or firmware configured to host the shared services for tenants. The hosted services may include tenant-specific business services or functions, including enterprise resource planning (ERP) services; customer relationship management (CRM) services; eCommerce services; Human Resources (HR) management services; financial services including, for example, payroll services, accounting services, subscription billing services, financial reporting and analysis services, or the like; calendaring services; order processing services; inventory management services; supply chain management (SCM) services; collaboration services; sales force automation (SFA) services; marketing automation services; support services including, for example, contact list management services, call-center support services, web-based customer support services, or the like; partner and vendor management services; product lifecycle management (PLM) services; and so forth. Similar to the tenant interfaces 110, in some example embodiments, the server systems 112 may support load balancing when multiple tenants (and/or multiple customers of tenants) attempt to access the multi-tenant system 102 concurrently. Further, in some example embodiments, each tenant may be associated with a subset of the total number of server systems 112 to support load balancing.

In some example embodiments, tenant data 116 for each tenant may be stored in a logical store across one or more datastores 114. In some example embodiments, each tenant uses a logical store that is not assigned to any predetermined datastores 114. Each logical store may contain tenant data 116 that is used, generated, and/or stored as part of providing tenant-specific business services or functions. In some example embodiments, the datastores 114 may include relational database management systems (RDBMS), object-based database systems, or the like. In some example embodiments, tenant data 116 may be stored across multiple datastores 114, with each datastore dedicated to a particular service (e.g., managing customer records, managing product and/or service consumption information, managing billing information, managing payment information, etc.).

In some example embodiments, the tenant data 116 may include subscription information, such as billing data and/or subscription status data (e.g., active, canceled, suspended, re-activated). Billing data may include billing invoice data (e.g., date of invoices and invoice amounts, overage charge dates and overage charge amounts, etc.); payment transaction data (e.g., date of payments, amount of payments, etc.); payment outcome data (e.g., whether a payment was successful or failed, and if failed, the failure response code); failed payment retry data (e.g., the number of retries attempted for a failed payment, the overall retry window, the timing of the failed payment retries, whether the retries were ultimately successful or not, etc.); payment method data (e.g., stored credit card/debit card information); payment plan data (e.g., annual billing, monthly billing, etc.); and/or service plan data (e.g., the name of a service plan). Subscription information may also include a geographic region and/or location information associated with a tenant, service, and/or subscriber. In some example embodiments, the tenant data 116 may include usage data (e.g., account activity data), such as data identifying new subscriptions; changes to subscribed products and/or services; cancellation of one or more products and/or services; subscriptions to new products and/or services as part of an existing subscription; application of discounts; loyalty program package changes (e.g., additional programs and/or services, special rates, or the like for loyal customers); reduction or increase of rates for products and/or services; and/or cancellation of a subscription. In some example embodiments, account activity data may include data indicative of subscriber product usage data (e.g., what channels the subscriber actually watches, what services and what level of consumption the subscriber receives, quality of the product and/or services, etc.).

In some example embodiments, the tenant data 116 may be stored in one or more data formats according to one or more data schemas. For example, subscription tenant data may be stored in a particular format and usage tenant data may be stored in another format. As used herein, data formats, or simply formats, may include data types; variable types; protocols (e.g., protocols for accessing, storing, and/or transmitting data); programming languages; scripting languages; data value parameters (e.g., date formats, string lengths, etc.); endpoint locations; and so forth. In some example embodiments, the tenant data 116 may be stored as data objects as part of an object-oriented data schema. The tenant data 116 may include parent data objects, where each parent data object is related to one or more child data objects via a parent-child dependency relationship. Any given parent data object may, in turn, be a child data object to one or more other parent data objects. Similarly, any given child data object may, in turn, be a parent data object to one or more other child data objects. In some example embodiments, the tenant data 116 may include tabular data including one or more database tables and corresponding tabular data contained therein. Tabular data of the tenant data 116 may be linked to corresponding object data of the tenant data 116.

In some example embodiments, the multi-tenant system 102 functions to provide uniform access to disparate services (e.g., microservices) and/or disparate datastores. For example, different services of the multi-tenant system 102 may manage (e.g., create, read, update, delete) tenant data 116 stored in different datastores 114. It will be appreciated that as used herein, a “service” may be single service and/or a set of services (e.g., a cluster of services). The datastores 114 may store data in different formats and/or the services may handle data differently. The services may each include a service provider interface (SPI) that provides data from the service and/or that receives data at the service in a common (or uniform) format, regardless of the original format that may be used by the service and/or datastores 114. In some example embodiments, the multi-tenant system 102 may define a uniform access specification that defines the common format that the services must comport with when receiving and/or providing data. Accordingly, each of the services may be accessed in a uniform manner, and data may be consumed from the services in a uniform manner, regardless of the internal specifications and/or operations of the service.

The data/communication network 104 may represent one or more types of computer networks (e.g., a local area network (LAN), a wide area network (WAN), etc.) and/or underlying transmission media. The data network 104 may provide communication between the systems, engines, datastores, components, and/or devices described herein. In some example embodiments, the data network 104 includes one or more computing devices, routers, cables, buses, and/or other network topologies (e.g., mesh network topologies). In some example embodiments, the data network 104 may include one or more wired and/or wireless networks. In various example embodiments, the data network 104 may include the Internet, one or more WANs, one or more LANs, and/or one or more other public, private, Internet Protocol (IP)-based, and/or non-IP-based networks.

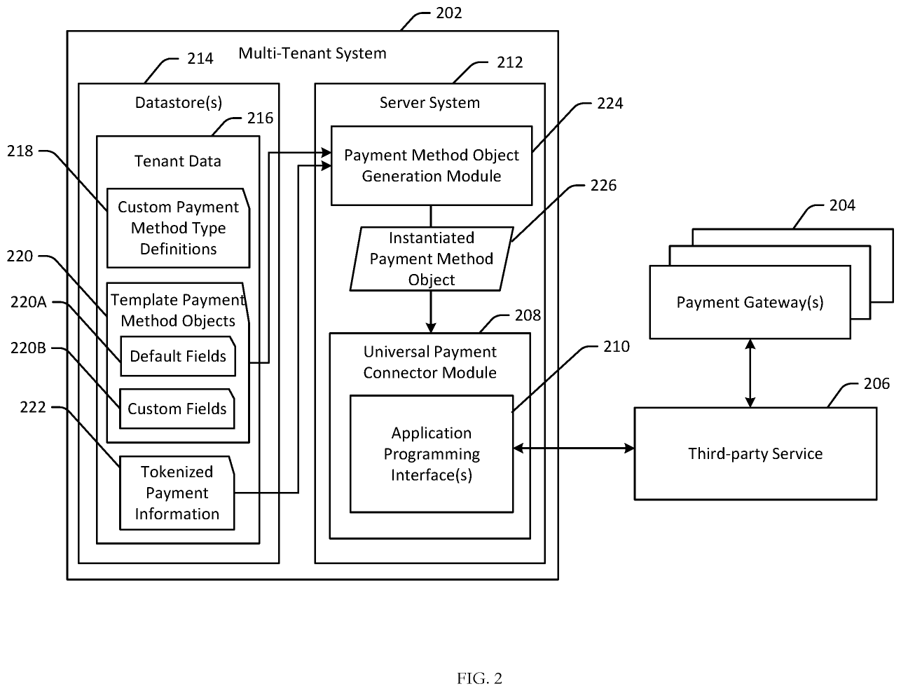

FIG. 2 depicts an example multi-tenant system 202 (which may be a particular implementation of the multi-tenant system 102 depicted in FIG. 1) and example components of the multi-tenant system 202 that are configured to support the functionality of various embodiments of the disclosed technology. For illustrative purposes, the tenant data 216 may include at least a portion of the tenant data 116 (FIG. 1). The tenant data 216 may be stored in one or more datastores 214, which may represent at least a portion of the datastore(s) 114 (FIG. 1). In some embodiments, the tenant data 216 may include respective data for each of multiple tenants. The tenant data 216 associated with a given tenant may include data at the tenant level such as subscription/product offering data, terms and conditions data, and/or the like that is generally applicable across subscribers of the tenant. The tenant data 216 associated with a given tenant may further include data at the individual subscriber/account holder level such as user profile/subscription data, user preference data, payment-related data (e.g., stored payment methods, billing history, etc.), and so forth.

The multi-tenant system 202 includes a server system 212, as shown in FIG. 2. The server system 212 may be a particular implementation of the server system 112 of FIG. 1. Various modules configured to provide their respective functionality may reside on the server system 112. In particular, as shown in FIG. 2, a payment method object generation module 224 and a universal payment connector (UPC) module 208 may reside and execute on the server system 212. In some embodiments, the payment method object generation module 224 and/or the UPC module 208 may include computer/machine-executable instructions executable by a processing unit to cause corresponding operations to be performed. The executable instructions may take the form of software, firmware, and/or hardware. For instance, in some embodiments, the payment method object generation module 224 and/or the UPC module 208 may include hardwired instructions/logic implemented as part of an application specific integrated circuit (ASIC), a field programmable gate array (FPGA), or the like.

In example embodiments, the UPC module 208 may be configured to connect a subscription billing service engine (not shown) of the multi-tenant system 202 to payment gateways 204. In some embodiments, a third-party service system 206 may communicate with the UPC module 208 via one or more application programming interfaces (APIs) 210. In this manner, the third-party service system 206 may access the subscription billing engine of the multi-tenant system 202 via the APIs 210 provided by the UPC module 208. Further, in this manner, the subscription billing functionality of the multi-tenant system 202 may be connected to the payment gateways 204 via the UPC module 208 and the APIs 210, which may be publicly available APIs accessible by any suitable third-party service system 206.

In example embodiments, the UPC module 208 obviates the need to perform any data transformation on the names of payment fields in a payment request sent from the multi-tenant system 202 to a payment gateway 204, and potentially routed through the third-party service system 206. In particular, because the APIs 210 provided by the UPC module 208 enable a third-party service system 206 to leverage the subscription billing services of the multi-tenant system 202 to cause, for example, the multi-tenant system 202 to send payment requests to the payment gateways 204 via the third-party service system 206, there no longer exists a need for the multi-tenant system 202 to generate a payment field mapping that maps field names natively used within the multi-tenant system 202 to payment field names specific to a particular payment gateway 204. Rather, the multi-tenant system 202 may simply send the payment request—in the form, for example, of a payment method object—via the UPC module 208 to the third-party service system 206, leaving the onus on the third-party service system 206 to then perform any necessary data transformation of payment field names to gateway-specific field names prior to routing the payment to a particular payment gateway 204. In this manner, the multi-tenant system 202 is not tasked with having to perform any data transformation of the payment fields of a payment request it sends out via the UPC module 208, thereby enabling the multi-tenant system 202 to scale new tenant integrations.

In some embodiments, the UPC module 208 may operate as a type of payment gateway itself. That is, by supporting public APIs 210 rather than proprietary ones, the UPC module 208 may enable any suitable third-party service system 206 acting on behalf of a tenant of the multi-tenant system 202 to access the subscription billing functionality of the multi-tenant system 202. In this manner, the UPC module 208 facilitates the generation of a sort of universal payment that can then be routed—potentially via the third-party service system 206—to any of various payment gateways 204.

In example embodiments, the multi-tenant system 202 may be configured to enable tenants to define custom payment method type definitions 218. In particular, in an example embodiment, the multi-tenant system 102 may support an API that a customer device 106 associated with a tenant may call to create a custom payment method type definition. This API may be one of the APIs 210 supported by the UPC module 208 or may be distinct therefrom. In example embodiments, a customer device 106 associated with a tenant (or a third-party service system 206 acting on behalf of the tenant) may call a specific API (e.g., a “create_custom_payment_method_type” API) and may deliver a payload to the multi-tenant system 202 via the API call. The payload may include a custom payment method type definition, which in turn, may specify one or more custom payment fields to include in payments that adhere to the custom payment method type definition. In some embodiments, the multi-tenant system 202 may determine that the payload includes the custom payment method type definition based on the payload being received via a call to the specific API.

The received payload may further specify a respective data type for each custom-defined payment field. For instance, a date of birth (DOB) payment field may have a date data type (e.g., a numeric format such as XX-XX-XXXX, where each X represents a numeral from 0-9), while a social security number (SSN) field may have a string data type. In some embodiments, the data types of two custom-defined fields may be of the same data type (e.g., strings), but may have different data sub-types. For instance, an SSN field may take numeric-only strings, while a social media/payment application handle field may be populated with an alphanumeric string. In some embodiments, the payload may be a Javascript Object Notation (JSON) payload containing key-value pairs, where each key-value pair associates an identifier (e.g., name) of a custom-defined payment field with the data type expected by the field.

In some embodiments, after receiving the payload containing the custom payment method type definition, the multi-tenant system 202 may store the custom payment definition as part of the tenant data 216 associated with the tenant to whom the definition corresponds. Further, in some embodiments, the multi-tenant system 202 may be configured to generate a template payment method object 220 from the custom payment method type definition 218. In particular, the multi-tenant system 202, or more specifically, the payment method object generation module 224 or another specialized module may identify one or more custom-defined fields 220B contained in the custom payment method type definition, and may append these custom fields 220B to one or more default payment fields 220B that are typically included in a payment method object to obtain the template payment method object 220. In some embodiments, the payload containing the custom payment method type definition may indicate one or more default payment fields that should be excluded from the custom definition. In such embodiments, the designated default payment field(s) may be excluded from the template payment method object that is generated. The template payment method object and the corresponding custom payment method type definition on which it is based may then be stored in association with an identifier of the tenant who created the custom definition.

In addition to an API that is callable to create a new custom payment method type definition, the multi-tenant system 202 may support additional APIs that may be callable to perform various operations with respect to a custom payment method type definition that has been created. For example, the multi-tenant system 202 may provide an API that is callable to publish a custom payment method type definition that has been created. In some embodiments, after a custom payment method type definition is published, it may become usable to generate payments that adhere to the custom definition. The multi-tenant system 202 may additionally provide an API that is callable to query an existing custom payment type definition to, for example, determine the custom payment field(s) included within the definition. As another non-limiting example, the multi-tenant system 202 may provide an API that is callable to update/modify a custom payment method type definition. For instance, a customer device 106 may call the update API to add a new custom-defined payment field to an existing custom payment method type definition, to delete an existing custom-defined field in the custom definition, to change the data type of a custom-defined field, or the like. Further, in some embodiments, a custom payment method type definition may be updated to add a default field that was originally excluded from the custom definition and/or to exclude a default field that was not originally excluded.

In example embodiments, a customer device 106 associated with a tenant of the multi-tenant system 202 (or an external third-party service system 206 acting on behalf of the tenant) may send a request for a payment to the multi-tenant system 202. In some embodiments, the request to create the payment may be received via a call to an API 210 supported by the UPC module 208. In some embodiments, the payment creation request may include tokenized payment information 222 that obscures the actual subscriber payment details (e.g., a bank account or credit card number) from the multi-tenant system 202. Responsive to receiving the payment creation request, the multi-tenant system 202 may determine whether a custom payment method type definition has been created for the tenant associated with the payment creation request. In particular, in some embodiments, the multi-tenant system 202 may locate a tenant identifier within the payment creation request and may search the tenant data 216 linked to that tenant identifier to determine whether the searched tenant data includes a custom payment method type definition.

In the event that it does, the system 202 may identify a subscriber identifier included in the payment creation request and retrieve payment attribute information stored in association with that subscriber identifier. The retrieved payment attribute information may include information for populating one or more default payment fields 220A as well as information for populating one or more custom-defined payment fields 220B of a payment method object generated based on the custom payment method type definition. For instance, in example embodiments, the multi-tenant system 202, or more specifically, the payment method object generation module 224 may locate a template payment method object representative of the custom payment method type definition, where the template object includes one or more default fields and one or more custom-defined fields specified by the custom definition, and may instantiate the template payment method object to generate an instantiated payment method object 226. The multi-tenant system 202 may then send the instantiated payment method object 226 to an endpoint designated in the payment creation request. In some embodiments, the multi-tenant system 202, or more specifically, the payment method object generation module 224 may append the tokenized payment information 222 to the instantiated payment method object 226. In other embodiments, the tokenized payment information 222 may be incorporated into the instantiated payment method object 226.

In some embodiments, the specified endpoint may be an external service system 206 that is configured to perform any data transformations that may be needed—such as to map field names in the payment method object received from the multi-tenant system 202 to payment gateway-specific field names—prior to routing the payment request to a payment gateway 204. In other embodiments, an external service system 206 may submit the request to create a payment to the multi-tenant system 202, and the endpoint specified in the request may be a network resource distinct from the payment requesting entity.

In some embodiments, instantiating the template payment method object to obtain the instantiated payment method object 226 may include populating the default fields and the custom-defined fields of the template object with the appropriate portions of the payment attribute information that have data types that match the expected data types of the fields. For example, the payment method object generation module 224 may instantiate a template payment method object corresponding to a custom payment method type definition by populating default fields such as a name field, an address field, and the like with the appropriate corresponding subscriber payment attribute information having the correct data types (e.g., alphanumeric strings), and populating custom-defined fields such as an SSN field or a DOB field with the corresponding subscriber payment attribute information having the correct data type (e.g., a numeric string of fixed size).

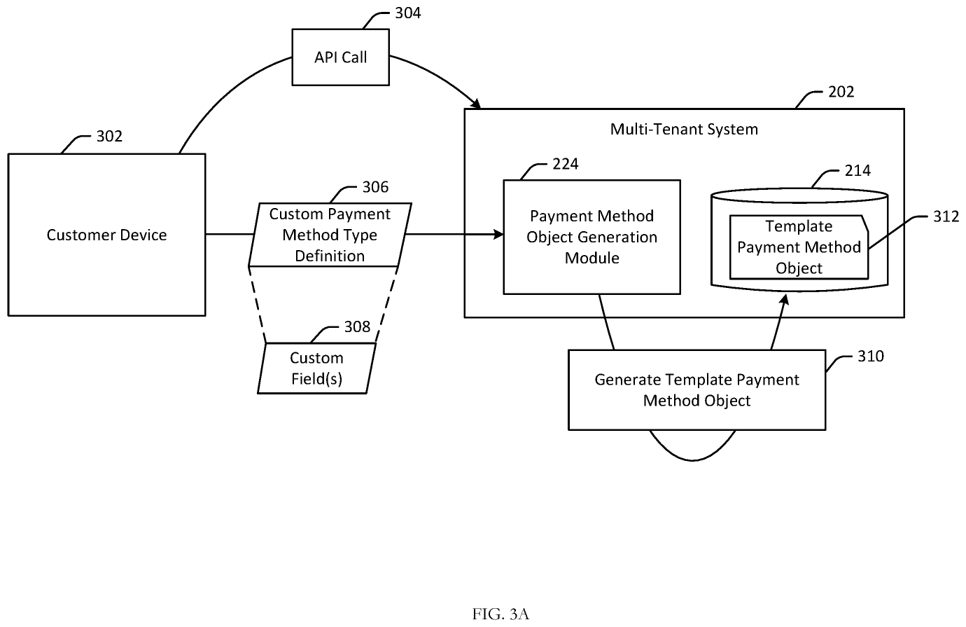

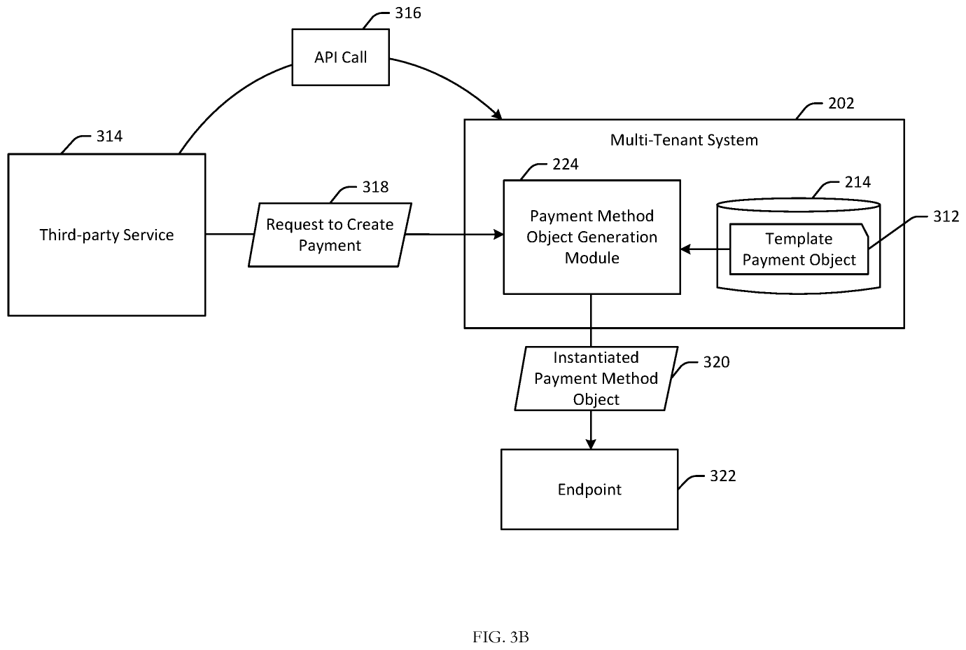

FIG. 3A schematically depicts a process for defining a custom payment method type in accordance with example embodiments of the disclosed technology. A customer device 302 is shown in FIG. 3A. The customer device 302 may be a particular type of customer device 106. The customer device 302 may be associated with a particular tenant of the multi-tenant system 202, for example. For instance, the customer device 302 may be operated by a representative/employee of a particular tenant. Alternatively, the customer device 302 may be a device operated by a subscriber of the particular tenant. In still other example embodiments, the customer device 302 may be a third-party external service system 206 acting on behalf of the particular tenant.

In an example embodiment, the customer device 302 may make a call 304 to an API to deliver a payload containing a custom payment method type definition 306 to the multi-tenant system 202. As previously described, the custom payment method type definition 306 may specify one or more custom-defined payment fields 308 to be included in payment method objects that are generated based on the custom definition. The API may be one that is specifically configured to receive payloads containing custom payment method type definitions. That is, in some embodiments, the multi-tenant system 202 may determine that the received payload includes the custom payment method type definition based on having received the payload via an API that is specifically configured to receive such payloads.

In some embodiments, the payment method object generation module 224 may generate 310 a template payment method object 312 based on the custom payment method type definition and store the generated template payment method object 312 in the datastore(s) 214 as part of the tenant data 216 that corresponds to the particular tenant. As previously described, generating the template payment method object may include appending the custom fields 308 to one or more default payment fields included in a standard/default payment method object to obtain the template payment method object 310. The custom payment method type definition 306 may be stored as part of the tenant data for the particular tenant as well. In some embodiments, the custom payment method type definition 306 and the corresponding template payment method object 312 may be linked to one another and to the corresponding tenant via one or more tenant identifiers.

In some embodiments, the multi-tenant system 202 may not generate and store the template payment method object 312 in advance. Rather, upon receipt of the custom payment method type definition 306, the multi-tenant system 202 may simply store the custom definition 306 in association with a tenant identifier of the corresponding tenant. Then, upon receipt of a payment creation request associated with the tenant, the multi-tenant system may determine that the custom payment method type definition 306 was previously defined for the tenant. The multi-tenant system 202 may then proceed to dynamically instantiate the payment method object by determining on-the-fly which default payment field(s) and which custom-defined payment field(s) are specified by the custom definition, retrieving subscriber payment attribute information related to the identified payment fields, and populating the payment fields with the appropriate attribute information having the respective data types expected by the various fields.

A custom payment method type definition has been described thus far as being created by or on behalf of a particular tenant of the multi-tenant system 202. However, in some embodiments, a custom payment method type definition may be defined for a particular subscriber or group of subscribers. That is, in some embodiments, a tenant or another requesting entity acting on behalf of a tenant may create different custom payment method type definitions for different subscribers or different groups of subscribers. For example, a first custom payment method type definition associated with a first subscriber or subscriber group may include a greater number and/or a different set of custom-defined fields than a second custom payment method type definition associated with a second subscriber or subscriber group, such that a payment created based on the first custom payment method type definition includes more and/or different payment attribute information associated with a subscriber than a payment generated based on the second custom payment method type definition. Different custom payment method type definitions may be defined for different subscribers/subscriber groups based, for example, on different subscription tiers associated with the subscribers, different levels of seniority, and so forth.

FIG. 3B schematically depicts a process for creating a payment based on a custom payment method type definition in accordance with example embodiments of the disclosed technology. FIG. 3B depicts a third-party service system 314 submitting a request 318 to create a payment to the multi-tenant system 202 via an API call 316. The third-party service system 314 may be a particular example of the third-party service system 206. The third-party service system 314 may be an external service system acting on behalf of a particular tenant. In other example embodiments, a customer device 106 more directly associated with a particular tenant may send the payment creation request 318.

In example embodiments, the payment method object generation module 224 may receive the payment creation request 318 via the UPC module 208. More specifically, the API call 316 may be a call to an API 210 supported by the UPC module 208. In example embodiments, the payment method object generation module 224 may determine an endpoint 322 specified in the request 318. The endpoint 322 may be a designated network resource to which the multi-tenant system 202 is to send the payment. Further, in example embodiments, the payment method object generation module 224 may locate an identifier (e.g., a tenant identifier) in the payment creation request 318 and may search tenant data linked to the tenant identifier to determine if a custom payment method type definition has been created for the tenant and/or for the particular subscriber to whom the payment creation request 318 relates (or a subscriber group that includes the particular subscriber). If no such custom definition exists, the payment method object generation module 224 may generate a standard/default payment method object responsive to the payment creation request. The payment method object generation module 224 may then send the default payment method object to the specified endpoint 322 via the UPC module 208, for example. Alternatively, in some embodiments, if no custom payment method type definition exists, the external service system 314 (or other requesting entity) may be required to call a different API that does not permit specifying an endpoint to receive the payment object, in which case, the multi-tenant system 202 may send the generated payment to the requesting entity itself.

In those embodiments in which a custom payment method type has been defined, the payment method object generation module 224 may locate the custom definition among tenant data associated with the particular tenant based, for example, on a stored association between the custom definition and a tenant identifier. In some embodiments, the payment method object generation module 224 may further retrieve a template payment method object 312 stored in association with the custom definition. The payment method object generation module 224 may then proceed to retrieve subscriber payment attribute information and populate the default field(s) and the custom-defined field(s) of the template payment method object 312 with the retrieved payment attribute information to obtain an instantiated payment method object 320. The multi-tenant system 202 may then send the instantiated payment method object 320 to the endpoint 322 designated in the payment creation request 318. In some embodiments, the multi-tenant system 202 may send the instantiated payment method object 320 to the endpoint 322 via the UPC module 208. In some embodiments, the multi-tenant system 202 may append tokenized payment information 222 to or incorporate the tokenized payment information 222 into the instantiated payment method object 320 prior to sending the payment method object 320 to the designated endpoint 322.

In some embodiments, the template payment method object 312 may not have been created based on the custom payment method type definition. In such embodiments, the payment method object generation module 224 may retrieve the stored custom payment method type definition and generate the payment method object dynamically on-the-fly. More specifically, responsive to receiving the payment creation request 318, the payment method object generation module 224 may locate the custom payment method type definition associated with the particular tenant to whom the payment creation request 318 relates, may identify the default and custom-defined fields specified in the custom definition, may retrieve the subscriber payment attribute information relevant to the payment, and may populate the identified fields with appropriate portions of the subscriber payment attribute information. In example embodiments, the payment method object generation module 224 may perform the above operations dynamically on-the-fly without relying on a template payment method object.

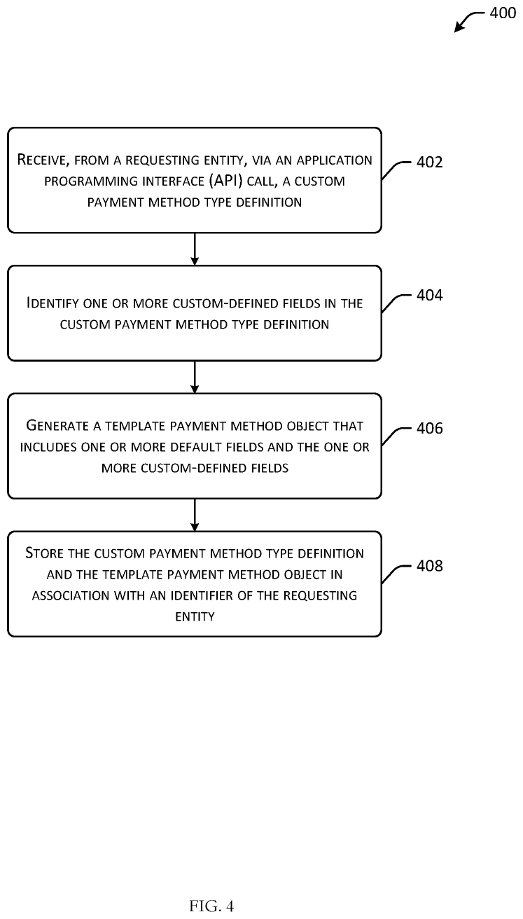

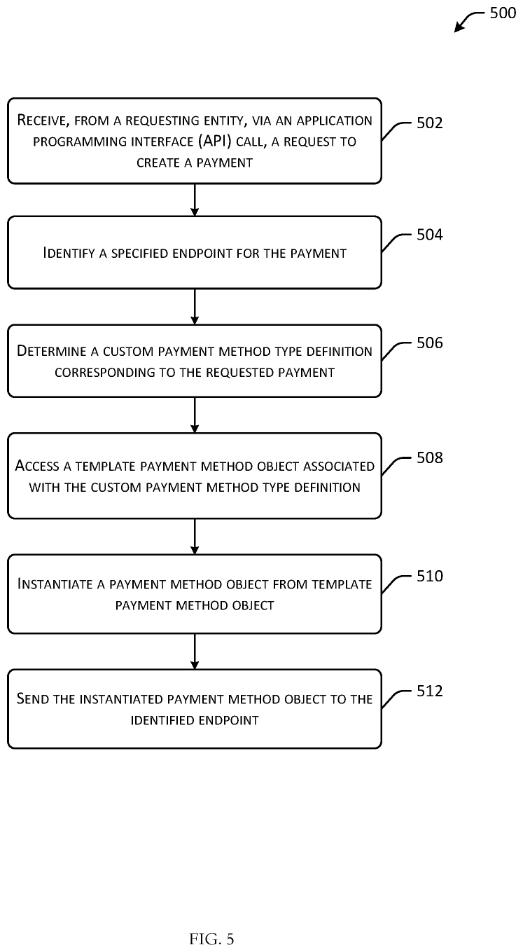

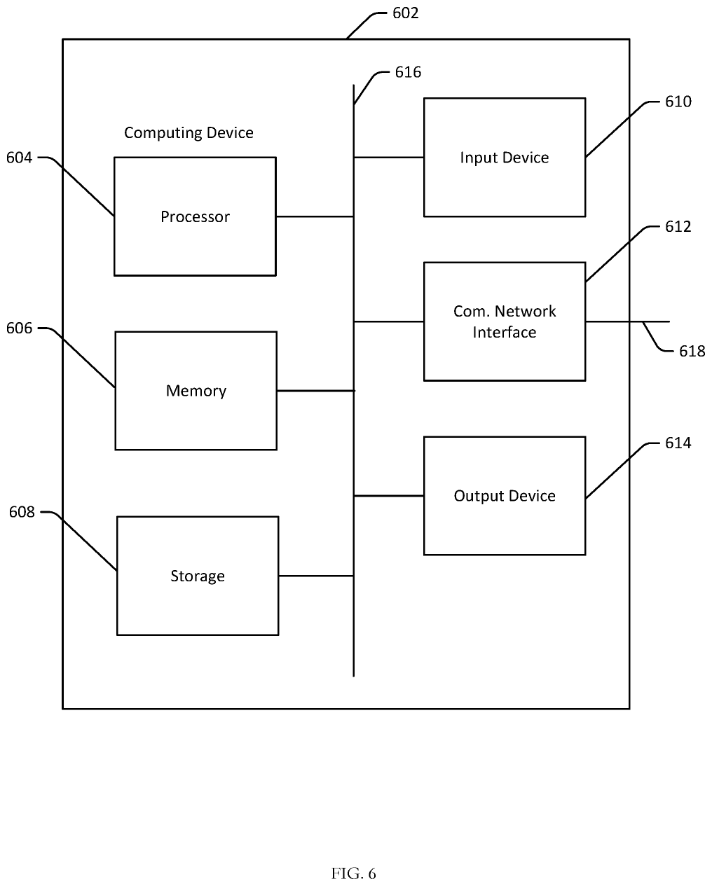

FIG. 4 is a flowchart depicting an illustrative method 400 of defining a custom payment method type in accordance with example embodiments of the disclosed technology. FIG. 5 is a flowchart depicting an illustrative method 500 of creating a payment based on a custom payment method type definition in accordance with example embodiments of the disclosed technology. In some embodiments, the method 400 and/or the method 500 may be performed responsive to execution, by one or more computer processors (e.g., any of the types of processors described later in this disclosure in reference to the processor 604 depicted in FIG. 6) of machine-executable instructions contained in one or more modules/engines executing on the server system 212 such as the payment method object generation module 224 and/or the UPC module 208. It shall be understood that reference herein to a particular module performing one or more operations may imply that the one or more operations are performed responsive to machine-executable instructions of the module being executed by one or more processors. The methods 400 and 500 may be described, at times, in reference to FIGS. 3A and 3B, respectively.

Referring now to FIG. 4, at block 402 of the method 400, the multi-tenant system 202 may receive from a requesting entity (e.g., customer device 302 associated with a particular tenant or an external service system 206 acting on behalf of the particular tenant), via an API call (e.g., API call 304), a custom payment method type definition (e.g., custom definition 306). More specifically, the multi-tenant system 202 may receive a payload via the API call that includes the custom payment method type definition.

At block 404 of the method 400, the multi-tenant system 202 may identify one or more custom-defined payment fields contained in the custom payment method type definition. In some embodiments, the custom payment method type definition may also specify the default payment fields to include in payments generated based on the custom definition. In other embodiments, the custom definition may only specify the custom-defined fields, and the multi-tenant system 202 may append these custom-defined fields to a predetermined set of default fields when generating a payment method object based on the custom definition.

At block 406 of the method 400, the multi-tenant system 202, or more specifically, the payment method object generation module 224 may generate a template payment method object (e.g., template payment method object 312) based on the custom payment method type definition. In some embodiments, the template payment method object may include both default payment fields as well as the custom-defined fields specified by the corresponding custom definition. Alternatively, the template payment method object may include only the custom-defined fields specified in the custom definition, and when generating a payment method object from the template payment method object, the payment method object generation module 224 may incorporate the default payment fields into the instantiated payment method object on-the-fly.

At block 408 of the method 400, the payment method object generation module 224 may store the custom payment method type definition and the corresponding template payment method object in association with an identifier of the requesting entity (e.g., a tenant identifier). It should be appreciated that, in some embodiments, the payment method object generation module 224 may not generate the template payment method object, in which case, only the custom definition may be stored.

Referring now to FIG. 5, at block 502 of the method 500, the multi-tenant system 202 may receive, from a requesting entity (e.g., an external third-party service system 314 acting on behalf of a particular tenant, a customer device 106/302 associated with the particular tenant, etc.), via an API call (e.g., API call 316), a request to create a payment (e.g., request 318). In some embodiments, the multi-tenant system 202 may determine that a custom payment method type definition exists for the particular tenant based on the particular API that is called to deliver the payment creation request. It should be appreciated that the remaining description of the method 500 assumes that a custom payment method type definition exists for the particular tenant for whom the payment creation request is submitted.

At block 504 of the method 500, the multi-tenant system 202, or more specifically, the payment method object generation module 224 may identify an endpoint (e.g., endpoint 322) specified in the payment creation request. The endpoint may be a network resource designated for receiving the payment method object that will be created. In some embodiments, the endpoint may be the requesting entity device—which may be a customer device 106/302 associated with a particular tenant or an external service system 314 acting on behalf of the particular tenant—or an external service system that is distinct from the requesting entity device.

At block 506 of the method 500, the payment method object generation module 224 may determine a custom payment method type definition (e.g., custom definition 306) corresponding to the payment creation request. More specifically, the payment method object generation module 224 may identify a tenant identifier contained in the payment creation request and may retrieve a custom definition stored in association with the tenant identifier.

Then, at block 508 of the method 500, the payment method object generation module 224 may access a template payment method object (e.g., template payment method object 312) associated with the retrieved custom payment method type definition. For example, the template payment method object may be stored in association with the custom definition (e.g., linked via the same tenant identifier), and the payment method object generation module 224 may access the template payment method object based on this stored association.

At block 510 of the method 500, the payment method object generation module 224 may instantiate the template payment method object to generate an instantiated payment method object (e.g., instantiated payment method object 320). As previously described, instantiating the template payment method object may include identifying custom-defined fields and default fields in the template payment method object, retrieving subscriber payment attribute information relating to the payment creation request, and populating the custom-defined fields and the default fields with appropriate payment attribute information based on the data types expected by the various fields. In other embodiments, the template payment method object may include only the custom-defined fields specified by the corresponding custom payment method type definition, which the payment method object generation module 224 may populate with corresponding payment attribute information, and then append to a set of default fields that are populated with their expected attribute information to obtain the instantiated payment method object. Then, at block 512 of the method 500, the multi-tenant system 202 may send the instantiated payment method object to the designated endpoint.

It should be appreciated that, in some embodiments, the operations at blocks 508 and 510 may not be performed. That is, in some embodiments, the payment method object generation module 224 may not create a template payment method object based on a custom payment method type definition. The payment method object generation module 224 may instead generate the payment method object on-the-fly responsive to receiving the payment creation request. That is, upon receiving the payment creation request, the payment method object generation module 224 may locate the custom payment method type definition corresponding to the particular tenant to whom the payment creation relates, and may proceed to populate custom-defined fields, and optionally, default fields specified in the custom definition with corresponding payment attribute information to ultimately obtain the payment method object.

FIG. 6 depicts a diagram of an example of a computing device 602. Any of the systems, engines, datastores, and/or networks described herein may comprise one or more instances of the computing device 602. In some example embodiments, functionality of the computing device 602 is improved to the perform some or all of the functionality described herein. The computing device 602 comprises a processor 604, memory 606, storage 608, an input device 610, a communication network interface 612, and an output device 614 communicatively coupled to a communication channel 616. The processor 604 is configured to execute executable instructions (e.g., programs). In some example embodiments, the processor 604 comprises circuitry or any processor capable of processing the executable instructions.

The memory 606 stores data. Some examples of memory 606 include storage devices, such as RAM, ROM, RAM cache, virtual memory, etc. In various embodiments, working data is stored within the memory 606. The data within the memory 606 may be cleared or ultimately transferred to the storage 608.

The storage 608 includes any storage configured to retrieve and store data. Some examples of the storage 608 include flash drives, hard drives, optical drives, cloud storage, and/or magnetic tape. Each of the memory system 606 and the storage system 608 comprises a computer-readable medium, which stores instructions or programs executable by processor 604.

The input device 610 is any device that inputs data (e.g., mouse and keyboard). The output device 614 outputs data (e.g., a speaker or display). It will be appreciated that the storage 608, input device 610, and output device 614 may be optional. For example, the routers/switchers may comprise the processor 604 and memory 606 as well as a device to receive and output data (e.g., the communication network interface 612 and/or the output device 614).

The communication network interface 612 may be coupled to a network (e.g., network 108) via the link 618. The communication network interface 612 may support communication over an Ethernet connection, a serial connection, a parallel connection, and/or an ATA connection. The communication network interface 612 may also support wireless communication (e.g., 802.11 a/b/g/n, WiMax, LTE, WiFi). It will be apparent that the communication network interface 612 may support many wired and wireless standards.

It will be appreciated that the hardware elements of the computing device 602 are not limited to those depicted in FIG. 6. A computing device 602 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 604 and/or a co-processor located on a GPU (i.e., NVidia).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A method, comprising:
receiving, at a multi-tenant system, via a call to a first application programming interface (API), a payload comprising a custom payment method type definition associated with a particular tenant of the multi-tenant system;
identifying one or more custom-defined payment fields in the custom payment method type definition;
generating a template payment method object comprising one or more default payment fields and the one or more custom-defined payment fields; and
storing the template payment method object in association with an identifier of the particular tenant.

2. The method of claim 1, further comprising:
determining that the payload comprises the custom payment method type definition based on receiving the payload via the call to the first API.

3. The method of claim 1, wherein identifying the one or more custom-defined payment fields comprises determining, from the custom payment method type definition, a respective data type for each of the one or more custom-defined payment fields.

4. The method of claim 1, further comprising:
receiving, at the multi-tenant system, via a call to a second API, a request to update the custom payment method type definition; and
modifying the custom payment method type definition responsive to receiving the request via the call to the second API.

5. The method of claim 4, wherein modifying the custom payment method type definition comprises at least one of adding a new custom-defined payment field, removing an existing custom-defined payment field, or changing a respective data type of the existing custom-defined payment field.

6. A computer program product comprising a non-transitory computer-readable medium readable by a processing circuit, the non-transitory computer-readable medium storing instructions executable by the processing circuit to cause a method to be performed, the method comprising:
receiving, at a multi-tenant system, via a call to an application programming interface (API), a request to create a payment;
identifying, from the request to create the payment, a specified endpoint for the payment;
determining a custom payment method type definition corresponding to the requested payment;
generating a payment method object based on the custom payment method type definition; and
sending the payment method object to the specified endpoint.

7. The computer program product of claim 6, wherein the specified endpoint is a system external to the multi-tenant system, the third-party service system being configured to transform one or more payment fields in the payment method object to one or more payment gateway-specific payment fields and send the payment method object to a particular payment gateway.

8. The computer program product of claim 7, wherein determining the custom payment method type definition corresponding to the requested payment comprises:
determining an identifier associated with the request to create the payment; and
determining that the custom payment method type definition is stored in association with the identifier.

9. The computer program product of claim 8, wherein the identifier identifies a particular tenant of the multi-tenant system.

10. The computer program product of claim 7, wherein generating the payment method object based on the custom payment method type definition comprises:
determining a plurality of payment fields included in the custom payment method type definition, the plurality of payment fields including one or more default payment fields and one or more custom-defined payment fields;
identifying payment attribute information relating to the request to create the payment; and
populating the plurality of payment fields with the payment attribute information.

11. The computer program product of claim 7, wherein generating the payment method object based on the custom payment method type definition comprises:
determining a template payment method object that corresponds to the custom payment method type definition; and
instantiating the template payment method object to generate the payment method object.

12. The computer program product of claim 11, wherein instantiating the template payment method object comprises:
accessing stored payment attribute information associated with the request to create the payment; and
populating a plurality of payment fields of the template payment method object with the payment attribute information.

13. The computer program product of claim 12, wherein populating the plurality of payment fields comprises:
identifying a custom-defined payment field among the plurality of payment fields;
determining an expected data type for the custom-defined payment field;
identifying a portion of the payment attribute information that corresponds to the custom-defined payment field;
determining that a data type of the portion of the payment attribute information matches the expected data type; and
populating the custom-defined payment field with the portion of the payment attribute information.

14. A multi-tenant system, comprising:
memory storing computer-executable instructions; and
at least one processor configured to access the memory and execute the computer-executable instructions to:
receive, via a call to a first application programming interface (API), a payload comprising a custom payment method type definition associated with a particular tenant of the multi-tenant system;
receive, via a call to a second API, a request to create a payment;
identify, from the request to create the payment, a specified endpoint for the payment;
determine that the custom payment method type definition corresponds to the requested payment;
generate a payment method object based on the custom payment method type definition; and
send the payment method object to the specified endpoint.

15. The multi-tenant system of claim 14, wherein the at least one processor is further configured to execute the computer-executable instructions to:
receive, via a call to a third API, a request to update the custom payment method type definition; and
modify the custom payment method type definition responsive to receiving the request via the call to the third API.

16. The multi-tenant system of claim 15, wherein the at least one processor is configured to modify the custom payment method type definition by executing the computer-executable instructions to at least one of add a new custom-defined payment field, remove an existing custom-defined payment field, or change a respective data type of the existing custom-defined payment field.

17. The multi-tenant system of 14, wherein the at least one processor is configured to determine the custom payment method type definition corresponding to the requested payment by executing the computer-executable instructions to:
determine an identifier associated with the request to create the payment, the identifier identifying the particular tenant; and
determine that the custom payment method type definition is stored in association with the identifier.

18. The multi-tenant system of claim 14, wherein, responsive to receiving the payload comprising the custom payment method type definition, the at least one processor is further configured to execute the computer-executable instructions to:
identify one or more custom-defined payment fields in the custom payment method type definition;
generate a template payment method object comprising one or more default payment fields and the one or more custom-defined payment fields; and
store the template payment method object and the custom payment method type definition in association with an identifier of the particular tenant.

19. The multi-tenant system of claim 18, wherein the at least one processor is configured to generate the payment method object based on the custom payment method type definition by executing the computer-executable instructions to:
access the stored template payment method object corresponding to the custom payment method type definition based on its stored association with the identifier of the particular tenant; and
instantiate the template payment method object to generate the payment method object.

20. The multi-tenant system of claim 19, wherein the at least one processor is configured to instantiate the template payment method object by executing the computer-executable instructions to:
access stored payment attribute information associated with the request to create the payment; and
populate a plurality of payment fields of the template payment method object with the payment attribute information.

21. The system of claim 20, wherein the at least one processor is configured to populate the plurality of payment fields by executing the computer-executable instructions to:
identify a custom-defined payment field among the plurality of payment fields;
determine an expected data type for the custom-defined payment field;
identify a portion of the payment attribute information that corresponds to the custom-defined payment field;
determine that a data type of the portion of the payment attribute information matches the expected data type; and
populate the custom-defined payment field with the portion of the payment attribute information.
